(19) United States
(12) Patent Application Publication
(10) Pub. No.: US 2007/0051143 A1
(43) Pub. Date: Mar. 8, 2007

(54) Door lock with controllable handle operation

(76) Inventors: Juha Raatikainen, Joensuu (FI); Petri Tirkkonen, Hammaslahti (FI)

Correspondence Address: SMITH-HILL AND BEDELL, P.C., 16100 NW CORNELL ROAD, SUITE 220, BEAVERTON, OR, 97006, US

(21) Appl. No.: 10/595,499

(22) PCT Filed: Oct. 5, 2004
(86) PCT No.: PCT/FI04/00582

§ 371 Date: Apr. 24, 2006

(30) Foreign Application Priority Data
Oct. 30, 2003 (FI) 20031579

(51) Int. Cl. E05B 59/00; E05B 63/14

(52) U.S. Cl. 70/107

(57) ABSTRACT

A door lock with controllable handle operation including a bolt (3), a follower (5) for moving the bolt and an operation axis (4), on both ends of which an actuator can be installed for operating the follower (5), whereby force transmission from either side of the lock to the follower (5) is established by means of movable coupling members (10a, 10b), which are controlled by a solenoid arrangement (8, 9) or the like, and in which the follower (5) is provided with two separate torsion units (6a, 6b) installed on the operation axis (4) on different sides of the follower (5) and turnably secured thereto, which units can be connected to force transmission with the follower (5) by utilising said coupling members (10a, 10b). The door lock comprises a selecting member (7) movable from one lock side to the other, which member retains the torsion unit (6a, 6b) selected in each case to be unturnable with respect to the follower (5), so that force transmission from the operation axis (4) to the follower (5) is connected on that particular side of the lock, and on the other side of the lock, force transmission from the operation axis (4) to the follower (5) can be selectively either connected or disconnected by means of said coupling members (10a, 10b) under the control of the solenoid arrangement (8, 9).

The invention relates to a door lock with controllable handle operation in accordance with the preamble of claim 1.

The control of a handle operation in a door lock by means of a solenoid arrangement or the like can be accomplished in different ways depending on the application. The arrangement may for instance be such that, when the solenoid is energized, it permits or enables access by using a handle, whereby force transmission from the handle to the bolt of the lock is connected. Alternatively, the solution may be reversed so that the arrangement allows access by using a handle, when the solenoid is de-energized. The choice of the operational mode of the arrangement depends on whether the safety of access, i.e. the safety of exit, or the security of the locked space is emphasized.

In practice, the arrangement is normally such that the door can always be opened from outside by a key-operated lock mechanism or the like and from inside by a handle, turning knob or the like, whereby the selective coupling of the handle operation requires at the same time a two-piece, i.e. divided, drive shaft. Depending on the location of application the arrangement can also be for instance such that the door is provided with a handle or the like on both sides, whereby the door can always be opened from one side by a handle and from the other side only selectively depending on the situation.

When installing a door lock of the above kind, a choice has to be made deciding for instance on which side of the door, and thereby on which side of the lock casing of the door lock, the selective handle operation needs to be arranged so that the same lock casing may be used for doors turnable in different directions. In the solution disclosed in the patent publication EP 1354112 a separate adapting member installed on the operation axis of the actuators of the lock is employed, whereby it prevents direct operation of the follower by the actuator on the selected side of the lock. In this case, force transmission is effected from the operation axis to the follower by means of a torsion unit under the control of a solenoid utilising a latch as a coupling member. On the other side of the lock force transmission is continuously connected.

The patent publication EP 537531 discloses a solution, by means of which constant force transmission from the operation axis to the follower can be established and transferred from one side of the lock to the other. In this solution, a separate selecting member that is movable from one side of the lock to the other side and interlocks the latch with the torsion unit on the selected side, is utilised, whereby force transmission is provided from the operation axis via the torsion unit and said latch to the follower. In this arrangement, constant force transmission is thus always established via the latch and on the other hand, no force transmission can be provided from the other side of the lock, whereby the arrangement does not include any kind of solenoid-based selection procedure either.

An object of the invention is to provide a novel solution, which offers a wide range of possibilities for installing and utilising the door lock so that the lock can always be used from one side of the door and the use from the other side is selectively controlled. According to the solution, the lock casing should, when installed in the door, be convertible so that it can be used in the door independently of the direction in which the door is to be turned. A further aim is that the changes made in the lock casing can, by means of the installation arrangement, be realized as simply and easily as possible without opening the lock casing. The solution should also have a simple and reliable structure.

The objects of the present invention can be achieved in a way described in greater detail in claim 1 and in the other claims. According to the invention, the door lock comprises a selecting member movable from one lock side to the other, which member retains the torsion unit (6a, 6b) selected in each case to be unturnable with respect to the follower (5), so that force transmission from the operation axis (4) to the follower (5) is connected on that particular side of the lock, and on the other side of the lock the force transmission from the operation axis to the follower can be selectively either connected or disconnected by means of said coupling members under the control of a solenoid arrangement. The arrangement does not require a separate adapting member to be installed on the operation axis. Thus, the torsion units and their spindle openings can be designed so that it is not at all possible to turn the follower directly from the operation axis, which tends to contribute to the security of the arrangement. On the other hand, since the selection is not made through the latch acting as a coupling member and the force transmission on the lock side exposed to continuous force transmission is not established via the latch, the strength requirements for the latch, consequently, are minor.

In practise, the selecting member is preferably a screw or the like movable in the direction of the operation axis. The follower is provided with a threaded opening for the selecting member. Thus, the selecting member can be installed into its place firmly, which secures the connection between the torsion unit and the follower.

According to one preferable embodiment of the invention the torsion units are provided with a recess or the like, which is shaped so as to receive at least a part of the selecting member. Thereby the selecting member can preferably be provided with an extended head, which cooperates with said recess or the like, when the selecting member is installed thereto.

From the viewpoint of force transmission an advantageous application is accomplished when the follower is provided with a guiding member extending to said recess or the like of the torsion unit in the direction of the mid-axis of the opening in the follower and being in cooperation with the selecting member. In addition, said guiding member may also be provided with a guiding surface, which is arranged to cooperate with the protrusion at the torsion unit, while the follower is being turned.

According to one alternative embodiment of the invention said opening of the follower is arranged in a protrusion and each of the torsion units is provided with a corresponding protrusion, respectively, in which an opening is arranged for the selecting member, whereby the openings can be arranged concentrically with respect to the opening in the follower for installing the selecting member.

In the following the invention is described by way of example with reference to the attached drawings, in which

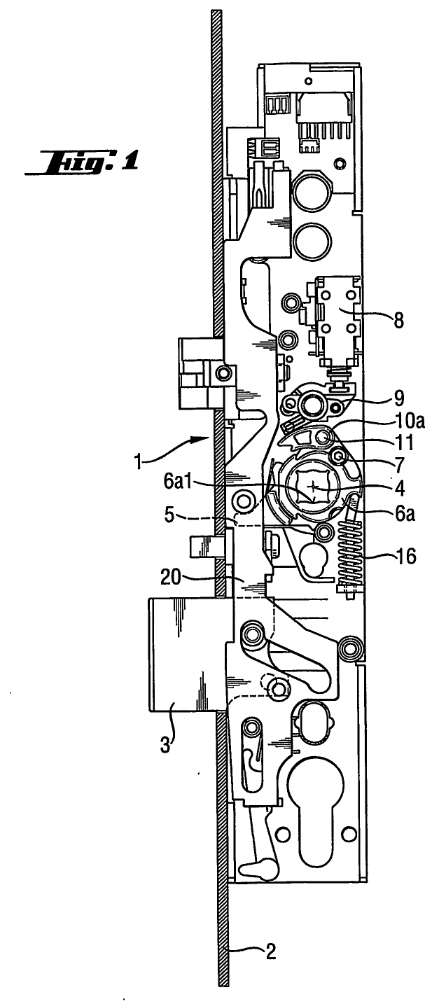

FIGS. 1-3 illustrate a door lock according to the invention showing a first embodiment of the follower unit in its various operating positions;

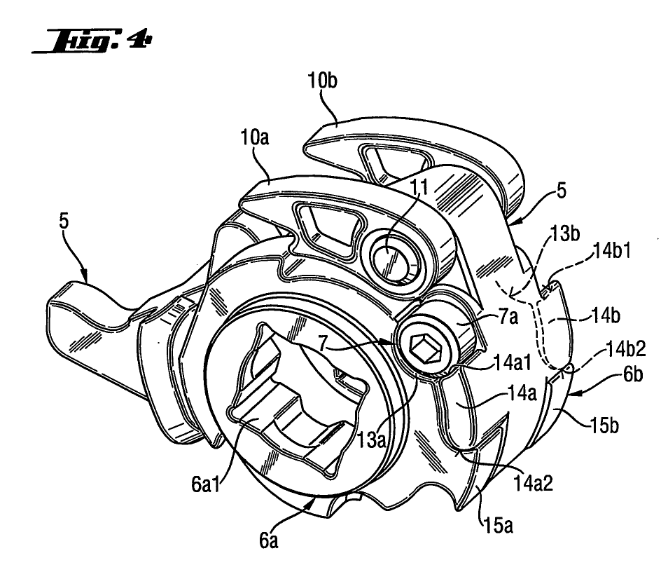

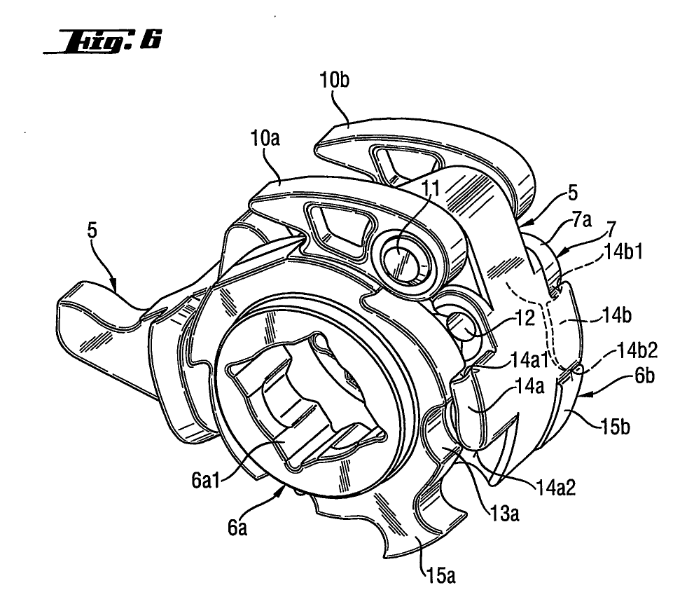

FIGS. 4-6 illustrate the embodiment of the follower unit according to FIGS. 1-3 enlarged in its various operating positions;

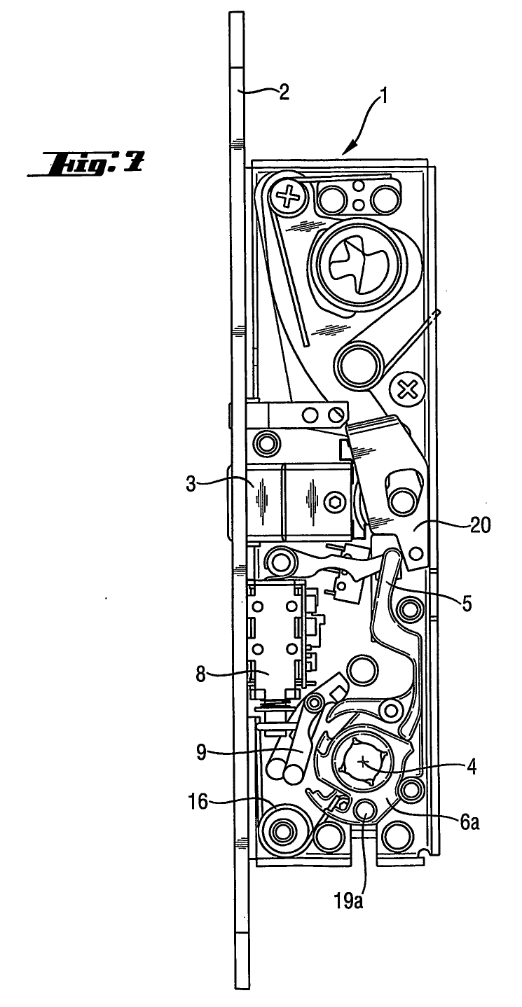

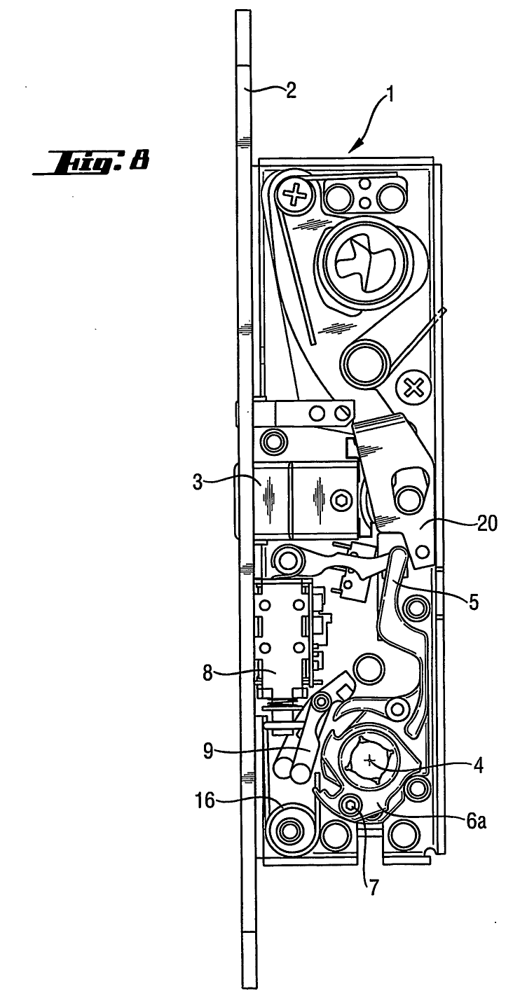

FIGS. 7 and 8 illustrate another door lock according to the invention showing a second embodiment of the follower unit in its various operating positions; and

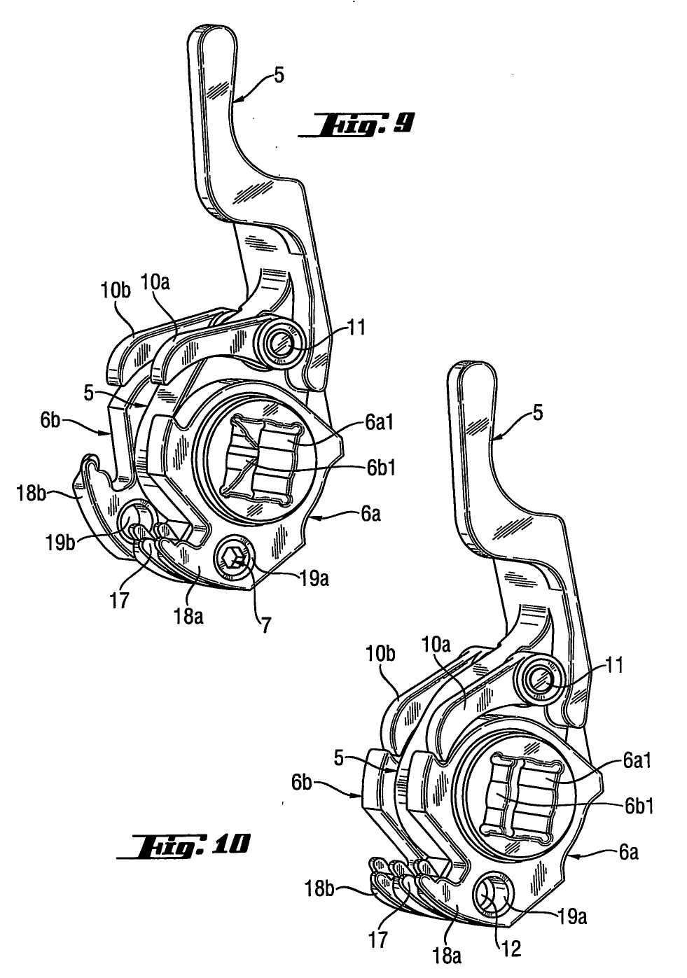

FIGS. 9 and 10 illustrate the embodiment of the follower unit according to FIGS. 7 and 8 enlarged in its various operating positions.

In the figures the reference number 1 indicates a lock casing of a door lock having a front plate 2, bolt 3 and an operation axis 4 provided with a turnable follower 5, which by means of a force transmission member 20 is arranged to move the bolt 3 from its locking position into its retracted position in the lock casing 1. The turning of the follower 5 is accomplished by an actuator (not shown) installed on the operating axis, for instance by means of a handle or a lock mechanism, whereby force transmission from the actuator to the follower 5 takes place from either side of the follower 5 by means of torsion units 6a, 6b, which are turnably secured thereto.

The door lock is further provided with a selecting member 7, preferably a screw, by means of which one of the torsion units 6a or 6b can be retained so that it is unturnable with respect to the follower 5, whereby force transmission from that particular side of the lock is constantly connected. Accordingly, the operation of the other torsion unit is then operable by means of a solenoid 8 so that a lever arrangement 9 turned by the solenoid 8 has an impact on a latch 10a or 10b acting as a coupling member and turnably pivoted on a stub shaft 11 arranged at the follower 5, which latch is selected to either connect or disconnect force transmission from the torsion unit to the follower 5. In order to accomplish force transmission the lever arrangement 9 presses the latch to its connecting position. The disconnection of force transmission may be provided for instance by providing the lever arrangement 9 with a magnet (not shown), which attracts the latch, as the solenoid 8 turns the lever arrangement 9 away from the operation axis 4. The basic operation of the arrangement is discussed also in the above-mentioned publication EP 1354112, whereto a reference is made in this respect.

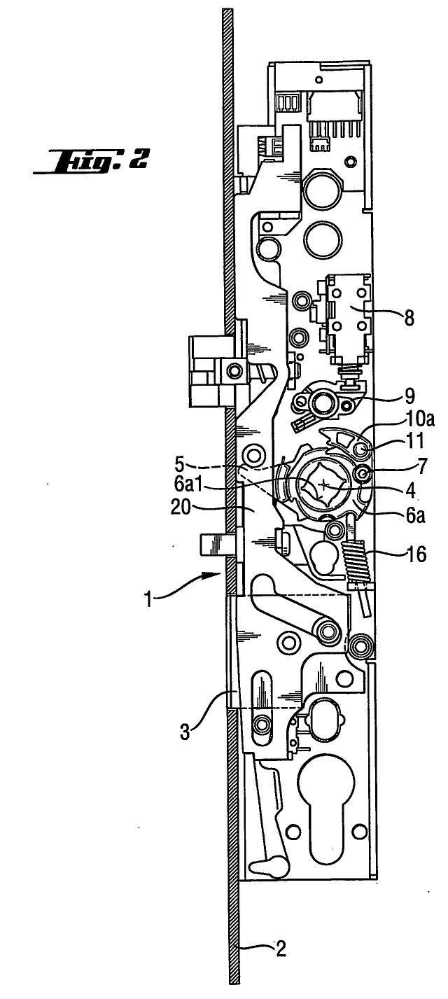

In the situation shown in FIG. 1 the foremost torsion unit 6a, i.e. the one shown in the figure, is by means of the selecting member 7 interlocked with the follower 5, whereby force transmission is continuously connected on the front side of the lock, i.e. from the operation axis via the follower 5 over to the bolt 3. In this case the actuator is either a key-operated lock mechanism or a handle or the like. A suitable actuator on the backside of the lock is a handle or the like, the operation of which can be controlled by the solenoid 8 so that there is selective force transmission from the handle to the bolt 3. In the situation according to FIG. 2 the bolt is retracted into the lock casing by turning the follower 5.

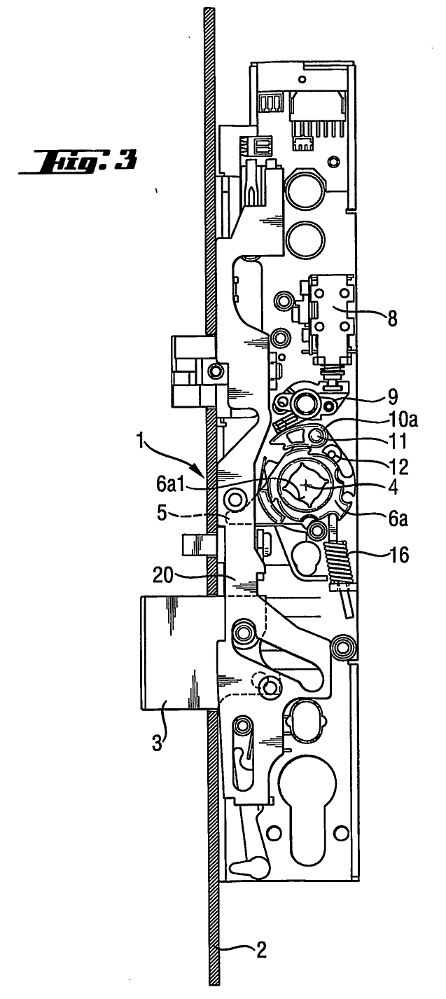

In the assembly according to FIG. 3 the selecting member 7 is moved to the other side of the lock and accordingly, it retains the torsion unit 6b (not shown in FIGS. 1-3) on the backside of the lock. In this case the moving of the bolt 3 depends on the position of the coupling member 10a controlled by the solenoid 8. In FIG. 3 the coupling member 10a is in its non-connecting position, whereby the bolt 3 cannot be moved from the lock side shown in the figure.

FIGS. 4-6 reveal the structure and cooperation of the follower 5 and the torsion units 6a and 6b in more detail. Here, two torsion units 6a and 6b are turnably adapted onto the respective sides of the follower 5. Since the torsion units have an identical structure and only one torsion unit 6a is clearly seen in figures, the structure of the torsion units is discussed in the following by referring mainly to said torsion unit 6a shown in the figures. The torsion unit has a spindle opening 6a1 for an actuator (not shown) to be installed on the operation axis 4. The torsion units are shaped and arranged in conjunction with the follower so that no direct force transmission from the operation axis 4 to the follower 5 exists.

The follower 5 is equipped with a stub shaft 11, onto which the latches 10a and 10b acting as coupling members are turnably secured, and with a threaded opening 12 in which the selecting member 7 is installed on the side of one of the torsion units in order to retain that particular torsion unit so that it is unturnable with respect to the follower. For this purpose the torsion unit 6a (6b) is provided with a recess 13a (13b), into which the expanded head 7a of the selecting member 7 can be placed. The follower 5 has a guiding member 14a (14b) extending to said recess 13a (13b) and being provided with a guiding surface 14a1 (14b1). When the selecting member 7 is in its locking position, it cooperates with both the recess 13a (13b) and the guiding surface 14a1 (14b1). The guiding member 14a (14b) is also in cooperation by its guiding surface 14a2 (14b2) with the protrusion 15a (15b) of the torsion unit. As shown in FIGS. 1-3 the protrusion 15a (15b) is affected by a spring arrangement 16, which aims at keeping the handle, which installed on the operation axis, in horizontal position.

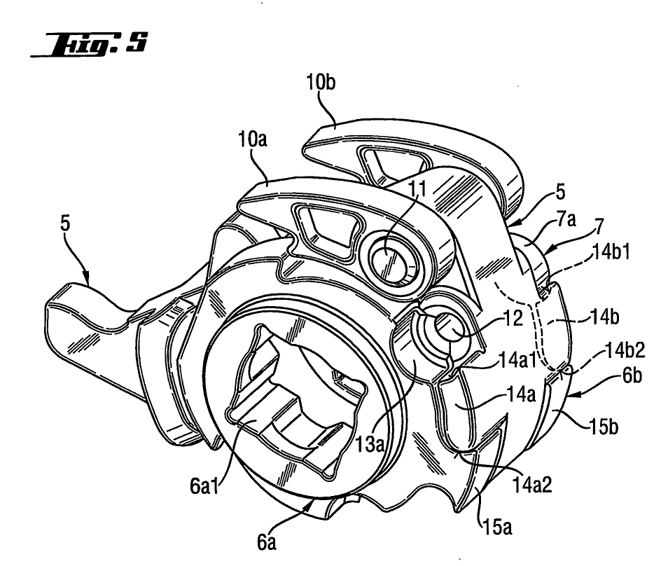

According to FIG. 4 the torsion unit 6a is by means of the selecting member 7 fixedly connected to the follower 5, and similarly in FIG. 5, the backmost torsion unit 6b is fixedly connected to the follower 5. In the latter case the foremost torsion unit 6a in the figure is free to turn and there is no force transmission from the operation axis 4 to the follower 5, as the coupling member 10a is not in its connecting position.

FIGS. 7 and 8 show another door lock utilising the second embodiment of the follower unit, the structure of which is shown in more detail in FIGS. 9 and 10. The basic operation is similar to the one in FIGS. 1-6, but in this case the threaded opening 12 for the selecting member 7 is arranged in the protrusion 17 of the follower 5. Accordingly, the torsion units 6a and 6b are provided with respective protrusions 18a and 18b having openings 19a and 19b, respectively, for the selecting member 7. Also in this case the torsion unit to be exposed to continuous force transmission is selected by means of the selecting member by installing it through the opening in said torsion unit into the opening in the follower.

In FIG. 9 the selecting member 7 is installed into the opening 19a of the torsion unit 6a, whereby the torsion unit 6a provides continuous force transmission to the follower 5. Similarly, the backmost torsion unit 6b can be selectively connected to force transmission with the follower 5 by means of the coupling member 10b. According to FIG. 9 the coupling member 10b is not in its connecting position, whereby the torsion unit 6b is independently turnable with respect to the follower 5 and there is no force transmission. In FIG. 10 the selecting member 7 is moved from the foremost torsion unit 6a to the backmost torsion unit 6b, whereby it is similarly interconnected with the follower and there is continuous force transmission via the torsion unit 6b to the follower 5. Since the latch 10a in this case is also in its connecting position, there is also force transmission from the torsion unit 6a to the follower 5.

The invention is not limited to the above-described embodiments, but several other modifications are conceivable in the scope of the appended claims.

1-6. (canceled)

7. A door lock with controllable handle operation including a bolt, a follower for moving the bolt and an operation axis, on both ends of which an actuator can be installed for operating the follower, whereby force transmission from either side of the lock to the follower is established by means of movable coupling members, which are controlled by a solenoid arrangement or the like, and in which the follower is provided with two separate torsion units installed on the operation axis on different sides of the follower and turnably secured thereto, which units can be connected to force transmission with the follower by utilising said coupling members, wherein it comprises a selecting member, being a screw or the like movable in the direction of the operation axis, the selecting member being movable from one lock side to the other, which member retains the torsion unit selected in each case to be unturnable with respect to the follower, that is provided with a threaded opening for the selecting member, so that force transmission from the operation axis to the follower is connected on that particular side of the lock, and that on the other side of the lock, force transmission from the operation axis to the follower can be selectively either connected or disconnected by means of said coupling members under the control of the solenoid arrangement.

8. A door lock according to claim 7, wherein the torsion units are provided with a recess or the like, which are shaped so as to receive at least a part of the selecting member.

9. A door lock according to claim 8, wherein the selecting member is provided with an extended head, which cooperates with said recess or the like, when the selecting member is installed thereto.

10. A door lock according to claim 8, wherein the follower is provided with a guiding member extending to said recess or the like of the torsion unit in the direction of the mid-axis of the opening in the follower and being in cooperation with the selecting member.

11. A door lock according to claim 10, wherein said guiding member is further provided with a guiding surface, which is arranged to cooperate with a protrusion at the torsion unit, while the follower is being turned.

12. A door lock according to claim 7, wherein said opening of the follower is arranged in a protrusion, and that each of the torsion units is provided with a corresponding protrusion, respectively, in which an opening is arranged for the selecting member, whereby the openings can be arranged concentrically with respect to the opening of the follower for installing the selecting member.
